(19) United States
(12) Patent Application Publication
(10) Pub. No.: US 2014/0188757 A1
(43) Pub. Date: Jul. 3, 2014

(54) Computer Systems and Methods for Determining Combinations of Investments Based On User-Defined Criteria

(71) Applicant: MASSACHUSETTS MUTUAL LIFE INSURANCE GROUP, Springfield, MA (US)

(72) Inventor: Frederick T. Schulitz, Weatogue, CT (US)

(73) Assignee: MASSACHUSETTS MUTUAL LIFE INSURANCE GROUP

(21) Appl. No.: 13/729,350

(22) Filed: Dec. 28, 2012

(51) Int. Cl. G06Q 40/06

(52) U.S. Cl. CPC G06Q 40/06
USPC 705/36 R

(57) ABSTRACT

A system and method for selecting a combination of investments are disclosed. According to one aspect, the system is configured to automatically select a combination of investments that can be mapped to investments in a current investment line-up by asset classification and which provide a matching solution based on defined investment objectives. According to another aspect, the system may dynamically generate different investment line-ups based on a variation of objectives provided by the user, and may display alternate investment line-ups simultaneously based on pre-defined line-up selection criteria.

### BACKGROUND

Embodiments of the present subject matter relate to an automated computer system and method for determining combinations of investments that meet user-defined criteria.

Selection of investments for an investment portfolio, such as a retirement portfolio, typically requires the analysis of a number of different and often competing investment objectives and criteria as they apply to many (e.g., thousands) of investment fund options. Investments can be combined in an almost limitless number of ways. In a conventional process, an analyst manually selects particular investment from a list of available investments in order to attempt to meet a set of investment objectives. This process of manually selecting investments and then testing their ability meet certain objectives often entails guesswork, is not efficient, and is not reproducible from one company analyst to the next. Moreover, given the magnitude in number of possible combinations of investments as well as the complexity introduced by multiple and potentially competing investment objectives, it is generally not possible to manually select an optimum combination of investments to generate an investment line-up.

### SUMMARY

According to one aspect, an apparatus is disclosed which includes computer memory storing data regarding a plurality of investments, a computer interface (e.g., a touch-screen display or a display that is operatively coupled to an input device such as a keyboard or mouse) configured to receive data indicative of a plurality of investment objectives, the investment objectives including an asset allocation by classification. The apparatus also includes an investment selection processing circuit operatively coupled to the memory and the interface and configured to generate combinations of investments from the plurality of investments based on the asset allocation by classification. Although the generated combinations are described to be based on the asset allocation, this does not exclude other factors (e.g., investment objectives, user specific selections, or the like) from contributing to the selection of the generated combinations. The investment selection processing circuit is also configured to determine, for each combination of investments from the combinations of investments, whether each combination of investments meets the plurality of investment objectives, and identify and output one or more combinations of investments based on said generating and said determining.

According to another aspect a method for selecting an investment line-up is disclosed which includes storing data in a computer memory regarding a plurality of investments, receiving, via a computer interface, data indicative of a plurality of investment objectives, the investment objectives including an asset allocation by classification, generating, via a processing circuit, combinations of investments from the plurality of investments based on the asset allocation by classification, determining, via the processing circuit, for each combination of investments from the combinations of investments, whether each combination of investments meets the plurality of investment objectives, and identifying and outputting one or more combinations of investments based on said generating and determining.

According to another aspect, a non-transitory computer readable medium having stored thereon a computer program product that is capable of being executed by computer processing circuitry is disclosed. The computer program product including instructions for causing the processing circuitry to store data in a computer memory regarding a plurality of investments, receive data indicative of a plurality of investment objectives, the investment objectives including an asset allocation by classification, generate combinations of investments from the plurality of investments based on the asset allocation by classification, determine for each combination of investments from the combinations of investments, whether each combination of investments meets the plurality of investment objectives, and identify and output one or more combinations of investments based on said generating and said determining.

### BRIEF DESCRIPTION OF THE DRAWINGS

FIG. 1 is a flowchart of a computer-implemented method of selecting a plurality of investments according to some embodiments.

FIG. 2 is a flowchart of an example of a computer-implemented method of generating an available investments database according to some embodiments.

FIG. 3 is a flowchart of an example of a computer-implemented method of computing investments scores according to some embodiments.

FIG. 4 illustrates a functional block diagram of a computer system for selecting a plurality of investments according to some embodiments.

FIG. 5 illustrates a user interface for a computer system for selecting a plurality of investments according to some embodiments.

FIG. 6 illustrates an example of a database of investment entries according to some embodiments.

FIG. 7 illustrates a computer display having selected investment line-up options.

### DETAILED DESCRIPTION OF EMBODIMENTS

According to some embodiments, computer systems and methods for selecting a combination of investments are disclosed. As described herein, the system may be configured to automatically select a combination of investments that provide an optimal, best available, or conforming selection based on defined investment objectives, which may be defined and/or adjusted by a user through a computer interface. In the accompanying examples described below, the systems and methods may be described in the context of an investment mapping process that selects a line-up of investments for a retirement plan. However, the scope of the systems and methods are not limited to retirement plans, and may be applied to the selection of investments for any type of investment portfolio. The users of the system may include, among others, investment advisors and employees of wealth management institutions. As described herein, an affiliated investment is an investment that is managed by the same entity generating the investment line-up for the portfolio, or is managed by an entity having an agreement with the entity generating the investment line-up for the portfolio.

Some examples of the investments that can be selected include, but are not limited to, mutual funds, insurance separate accounts, or collective investment trusts. In some embodiments, the system may utilize a pre-selected pool of affiliated and non-affiliated investments that are considered high quality investments in their asset class due to competitive expense ratios, revenue sharing, and/or historical investment performance. In other embodiments, the system may utilize a dynamically selected pool of affiliated and non-affiliated investments based on investment objectives.

The system is capable of selecting an optimal, best available, or conforming investment combination which meets the investment objectives. In some embodiments, a score may be assigned to each combination of investments in the investment pool based on the extent that the combination of investments meets the investment objectives. In some embodiments, the selected investment solution includes the combination of investments from the investment pool having the highest score among the possible investment combinations. In some embodiments, the scores and combinations may be output to a user to allow the user to select the desired combination. Relative to conventional investment selection mechanisms, the disclosed system is capable of generating a superior investment line-up that simultaneously meets both underwriting and client objectives, reduces a considerable amount of time and expended human resources, provides reliable and repeatable results, and provides a variety of alternative combinations simultaneously in order to meet different objectives and defined strategies.

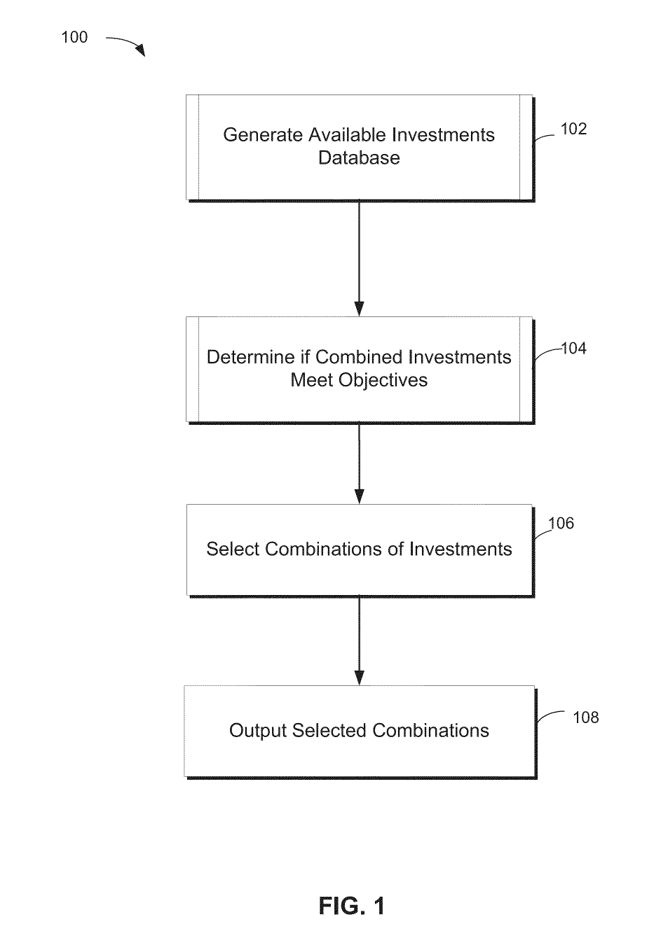

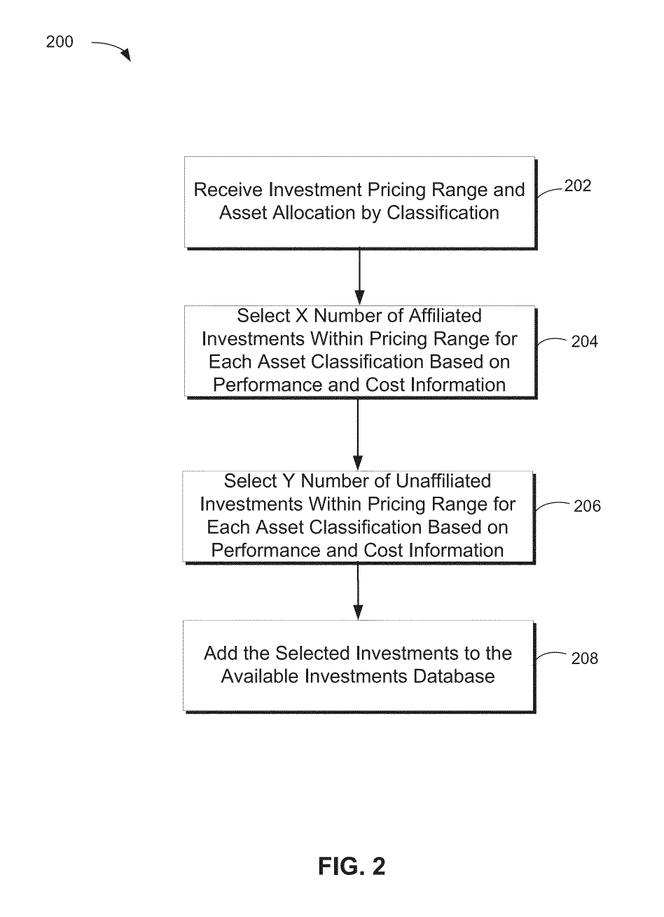

FIG. 1 is a flowchart of a computer-implemented method 100 of selecting a plurality of investments according to some embodiments. The computer-implemented method 100 includes a sub-process of generating a database of available investments as shown in block 102. In some embodiments, the investment selection pool may be dynamically generated based on investment criteria provided by the user. For example, a user may enter particular criteria related to expense ratios or historical performance. In some embodiments, the expense ratios may be divided into two components, a pricing component and a cost component. The pricing component may indicate the revenue that will be generated for the underwriting institution or investment planner, while the cost component may indicate the amount of other expenses that are not associated with the underwriting institution or investment planner. The method may include querying a database storing data related to all potential investments, and may filter the potential investments utilizing the particular user defined criteria to populate an available investments database. In other embodiments, the investment selection pool may be a pre-defined list of investments that are manually maintained by an investment manager or institution. An example of the sub-process shown in block 102 will be described with reference to FIG. 2 below.

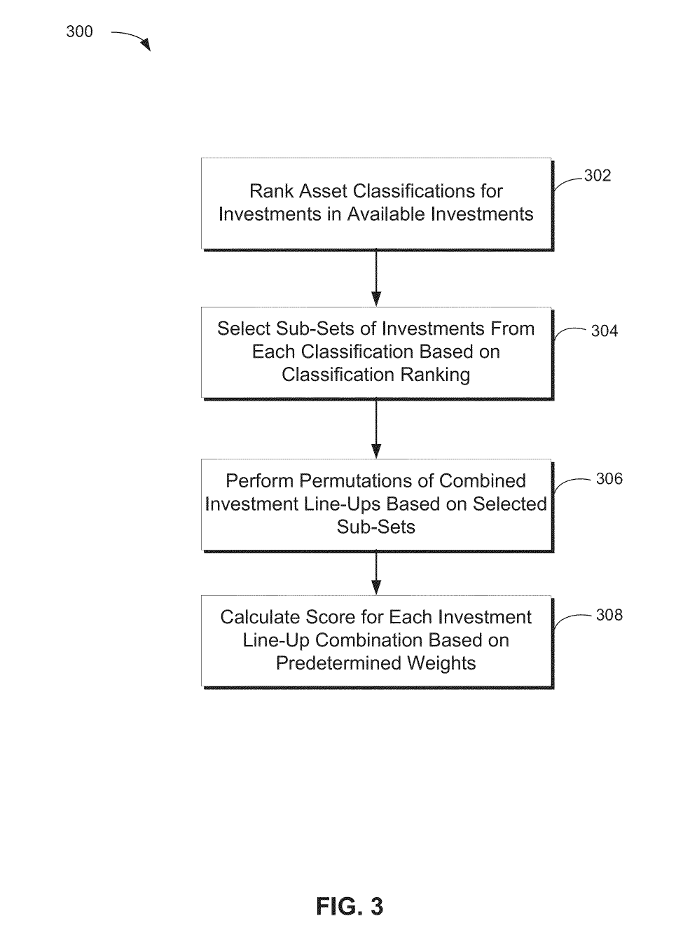

The computer-implemented method 100 also includes a sub-process of determining if the combination of investments meets the investment objectives as shown in block 104. In some embodiments, combined investment scores may be calculated which are based on user defined investment and underwriting objectives. For example, to generate the scores, combinations of investments in the investment pool are produced, and each combination is assessed based on measures of expense ratios and historical performance. An example of the sub-process shown in block 104 will be described with reference to FIG. 3 below. The computer-implemented method 100 also includes selecting combinations of investments as optimal, or otherwise matching solutions, matching the investment and underwriting objectives as shown in block 106. As shown in block 108, the selected combinations may then be provided as an output (e.g., displayed) to a user.

FIG. 2 is a flowchart of an example of a computer-implemented method 200 of generating an available investments database according to some embodiments. As shown in FIG. 2, the method 200 includes receiving an investment price range and asset allocation by classification as shown in block 202. The method 200 also includes selecting a number (X) of affiliated investments within the price range for each asset classification based on performance and cost information as shown in block 204. The method 200 also includes selecting a number (Y) of unaffiliated investments within the price range for each asset classification based on performance and cost information as shown in block 206. For example, for X=Y=2, two affiliated investments within each classification and two unaffiliated investments within each classification may be selected. The selection may include the affiliated and unaffiliated investments that have the best historical performance regardless of cost, as well as the affiliated and unaffiliated investments based on a combination of historical performance (e.g., average to above average performance) and cost (e.g., below average cost). The selected investments are then added to an available investments database to form the investment pool for the line-ups as shown in block 208.

FIG. 3 is a flowchart of an example of a computer-implemented method 300 of computing investments scores according to some embodiments. The method 300 shown in FIG. 3 may be utilized as one example of reducing the number of computations performed by the system. The method 300 includes ranking each asset classification of the investments that are available in the available investments database as shown in block 302. For example, the asset classifications can be ranked by size or investor preference. The method 300 also includes selecting sub-sets of investments from each classification based on the classification's ranking as shown in block 306. For example, if the investments include investments having four different classifications, each investment classification can be ranked from one to four. Investments from the lower ranked classifications may be excluded while the majority of investments in the higher ranked classifications may be included. As a result, the number of combinations may be reduced, thereby reducing the computations performed by the system. For each combination of investment line-ups, aggregate performance, pricing, and cost values may be determined as shown in block 308. In some embodiments, a weighted average of the aggregated values (e.g., 40% of 3 year performance and 60% of the 5 year performance) can be determined in order to determine a score for each of the investment line-up combination. In some embodiments, the performance may be evaluated relative to a performance benchmark for each of the investments in the line-up being evaluated. The benchmarks may be selected by the institution and can include one or more of a comparable investment or group of investments that are generated by the institution or that are determined by other institutions (such as Barclays, Russel, S&P, or the like).

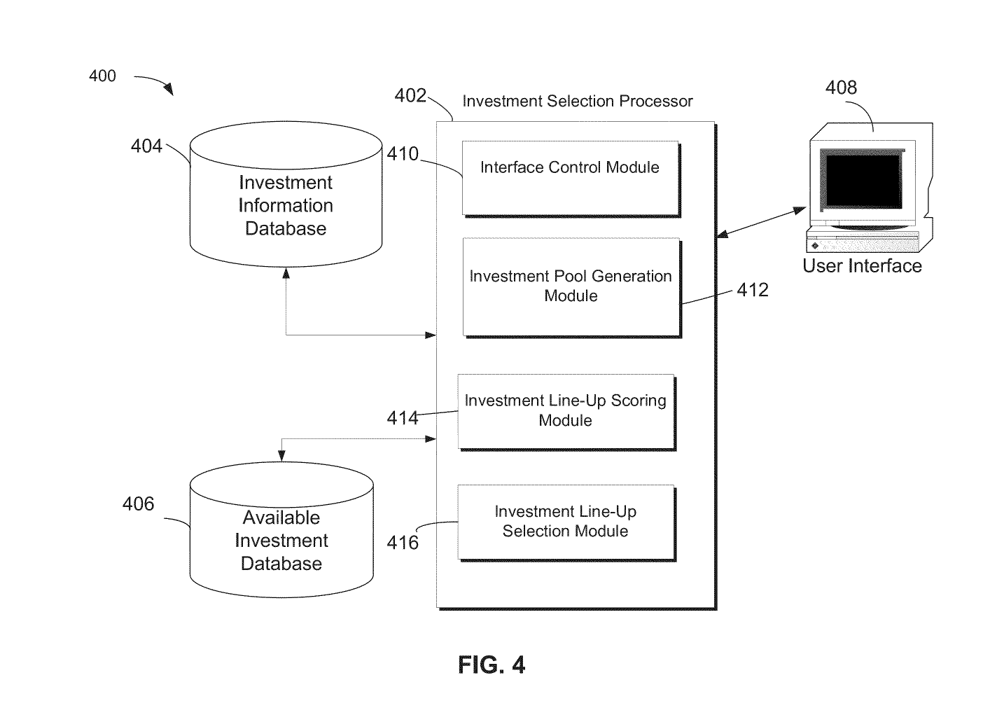

FIG. 4 illustrates a functional block diagram of a computer system 400 for selecting a plurality of investments according to some embodiments. The computer system 400 includes an investment selection processor 402 that is in communication with an investment information database 404, an available investments database 406, and a user interface 408. While shown separately, each of the investment selection processor 402, the investment information database 404, the available investments database 406, and the user interface 408 may be integrated in a single device having a memory storing the databases 404 and 406 and processing circuitry implementing the investment selection processor 402. In other embodiments, each of the investment selection processor 402, the investment information database 404, the available investments database 406, and the user interface 408 may reside in separate devices that are configured to communicate with one another over one or more network(s) such as the internet. The user interface 408 may include a touch-screen display and/or may be a display that is operatively coupled to an input device such as a keyboard or a mouse.

The investment selection processor 402 may include a plurality of modules for implementing particular functions. The investment selection processor 402 may correspond to a general purpose processor or processing circuitry that is configured to receive and execute instructions for performing the functions which will be described in greater detail below with reference to each of the modules. Further, each of the modules may be implemented in hardware or software. When implemented in software, each of the modules may be implemented by the same or different general purpose processors or processing circuits that are configured to execute the instructions contained therein. As shown in FIG. 4, the investment selection processor 402 includes an interface control module 410 that is configured to perform processing that enables communication with the user interface 408. The investment selection processor 402 also includes an investment pool generation module 412. The investment pool generation module 412 may be configured to query the investment information database 404 in order to generate a set of investments that are to be included in the investment selection pool. The investment pool is then stored by the investment pool generation module 412 in the available investments database 406. The investment pool generation module 412 may be configured to filter the set of available investments found in the investment information database 404 based on defined criteria, such as threshold levels for expense ratios (including one or both of pricing and cost components), threshold levels for historical rates of return, and asset classification that are provided by a user through the user interface 408. The investment pool generation module may also query the investment information database 404 for information related to particular investments. For example, a user may request that particular investments, such as those investments in the current investor portfolio, be included in the investment pool in addition to the defined criteria. The investment pool generation module 412 may be configured to query the investment information database 404 for information (such as classification, expenses, and historical performance) regarding the identified investment. The investment information database 404 may be maintained locally by the user's institution, or may be derived and periodically updated using third party reports (such as MorningStar, Bloomberg, or the like).

The investment selection processor 402 also includes an investment line-up scoring module 414. The investment line-up scoring module 414 may be configured to generate combinations of investments selected from the available investments database 406 and generate a score based on the underwriting and investment objectives. In some embodiments, the generated score may be based on weights that are assigned to different investment objectives, such as cost, periodic rates of return, and underwriting estimated pricing. The assigned weights may be varied by the user through entries to the database, and may be processed and stored by the investment selection processor 402. The investment selection processor 402 also includes an investment line-up selection module 416. The investment selection line-up module 416 may be configured to select, from among the sets of combined investments, one or more combinations of investments having the highest scores for the particular investment objectives. The selected sets of combined investments may then be displayed to the user via the user interface 408 through operation of the interface control module 410.

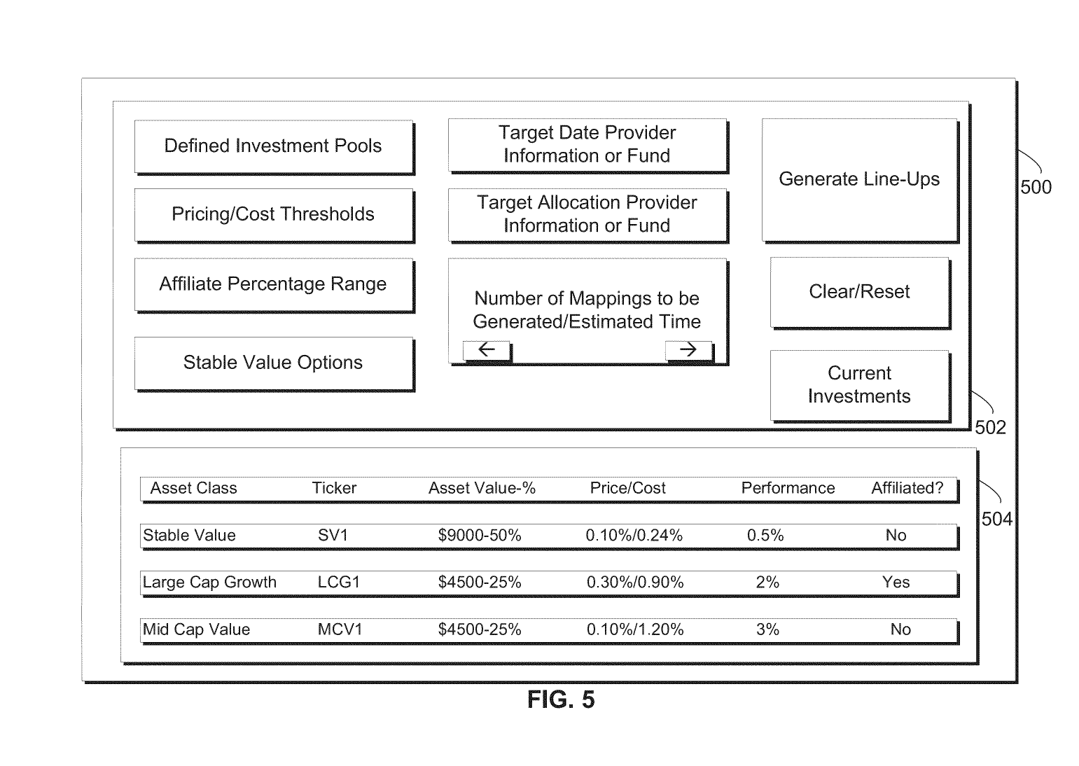

An example line-up selection process will be described in greater detail with reference to FIGS. 5-7. FIG. 5 illustrates a user interface 500 for a computer system for selecting a plurality of investments according to some embodiments. The user interface 500 as shown in FIG. 5 may correspond to the user interface 408 discussed above with reference to FIG. 4. The user interface 500 includes a user input section 502 having a plurality of defined fields for user input. As shown in FIG. 5, the fields of the user input section 502 include a field for user defined investment pools to be included, a field for pricing thresholds, a field for affiliate percentage range, a field for stable value options, a field for target date information or fund, a field for target allocation information or fund, and a field for current investments. Each of these fields may be entered by a user in order to generate the investment line-up.

For example, the interface 500 is configured to receive information related to a current investment line-up. This information can be entered by a user by entering each of the investments (e.g., by name or ticker) as well as the assets allocated to that investment. The interface control module 410 may then pass this information to the investment pool generation module 412 in order to retrieve classification, cost, and performance information related to the particular investment from the investment information database. Once located, the investment information is added to the available investments database 406 by the investment pool generation module 412, and at least some of the information is passed to the user interface 408 through the interface control module 410 for display to the user. These investments are displayed and populated with the corresponding information as shown, for example, in investment display area 504 of the user interface 500. While not shown, in some embodiments, through the interface 500, a user can indicate whether these investments should be kept in the new line-up. As shown in FIG. 5, a user can also indicate whether any substitution for these investments having the same allocation and investment classification must remain affiliated. In the event that fields related to the current investments are not automatically populated by the system, a user may also manually enter any missing information as necessary through interaction (e.g., via drop-down menus, text entry areas, or the like) with the appropriate field within the investment display area 504.

As shown in FIG. 5, user may enter a pre-defined investment pool that is identified in the system such that, when the pre-defined pool information is passed to the investment pool generation module 412, the available investments database 406 is populated by the set of investments that are included in the pre-defined investment pool identified by the user. The user or a pool manager can manipulate the pre-defined investment pool in order to include or exclude particular investments from the investment pool.

In some embodiments, a user can also enter particular pricing/cost thresholds for the line-up that is to be generated. The cost component can indicate a range of expenses that the investment line-up will incur that are unrelated to the underwriting institution, while the pricing component may indicate thresholds objectives of the underwriting objectives for the investment line-up. The combination of the cost and pricing components amount to the total expenses as seen by an investor. The pricing thresholds may be dictated by the value of the assets to be invested, as well as a measure of relative price strength. The factors that may be considered in determining the relative price strength values may include plan services required for the investment line-up, plan asset size of the investment line-up, expected annual cash flows of the investment line-up, and average participant balance for the combined investments in the investment line-up. The interface 500 is also configured to receive an affiliate percentage range for the investments to be selected. For example, a user can indicate that the selected investments in the combination must include at least 20% and no more than 40% affiliated investments. The interface 500 is also configured to receive one or more of a stable value investment identified by the user, a target date provider or target date fund identified by the user, and a target allocation provider or target allocation fund identified by a user.

The entries received by the interface 500 are communicated, through the interface control module 410, to the investment line-up scoring module 414, the investment pool generation module 412, and the investment line-up selection module 416. The investment line-up scoring module 414 may be configured to generate an estimate of the number of combinations that will be generated based on the investments in the available investments database 406 and the investment objectives. The number of combinations, and an estimate of the amount of time for processing the combinations and scores, may be illustrated to the user through the user interface 500 as shown in FIG. 5. In some embodiments, a sliding scale may be provided such that the number of investment combinations to be considered may be increased or decreased through interaction with the user interface 500. For example, a user may lock certain entries such that they cannot be modified without manually entering different values in the designated fields. Interacting with the sliding scale of the interface 500 may automatically modify some of the objectives entered by the user that are not locked in order to include or exclude investments, thereby increasing or decreasing the number of combinations that are to be generated. In some embodiments, interaction with the sliding scale may dynamically adjust one or more of the number of investments (e.g., X and Y as discussed above with reference to FIG. 2) that are selected from each asset classification for populating the available investment database. In some embodiments, interacting with the sliding scale may dynamically adjust the number of investments to be excluded based on the classification's ranking as discussed above with reference to FIG. 3. Once a user is satisfied with the entries, clicking the generate line-ups field will trigger the investment line-up scoring module 414 to generate the combinations and corresponding scores, and the investment line-up selection module 416 will in turn select one or more combinations as the optimum solution based on the objectives and the current asset allocation.

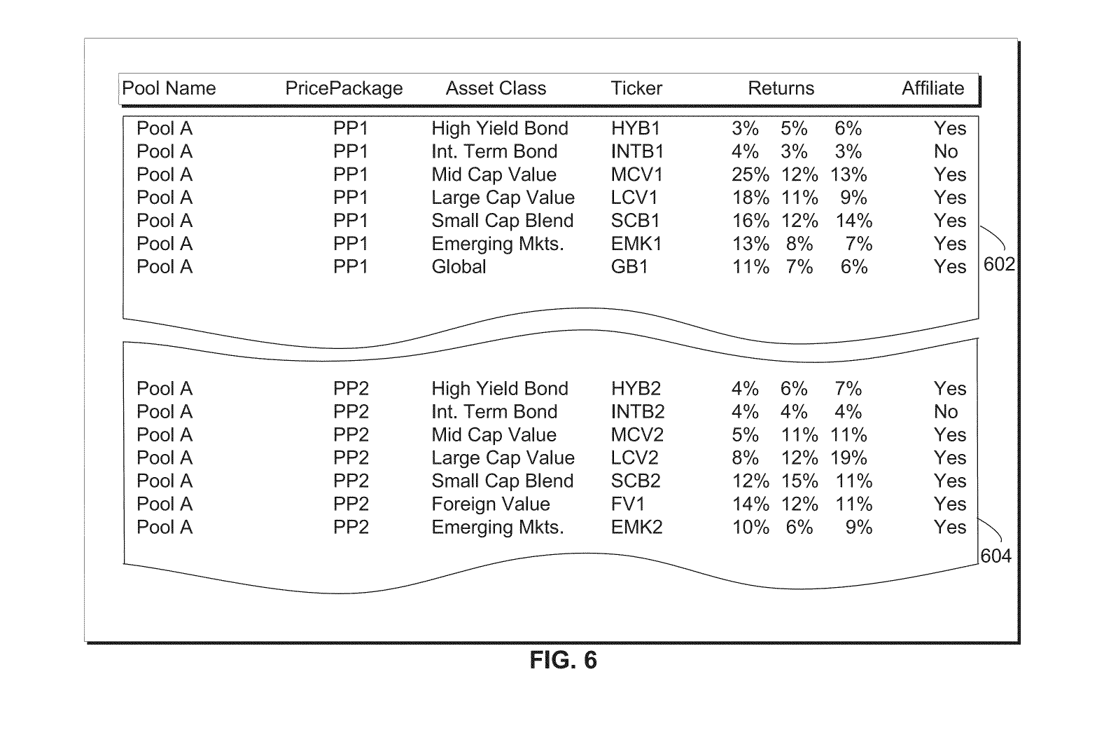

FIG. 6 illustrates an example of a database of investment entries according to some embodiments. The entries shown in FIG. 6 may correspond to entries found in the available investments database 406 discussed above with reference to FIG. 4. In the example shown in FIG. 6, information related to each investment that is stored in the database includes the pool name, a price package, an asset classification, the investment name or ticker, historical returns, and an indication of whether the investment is an affiliated investment or a non-affiliated investment. While not shown, other information related to the investment is also stored in the database, such as inception date, the investment's corresponding pricing information (e.g., revenue rate for the institution), the cost associated with the investment that is not attributable to the institution, and/or an overall expense ratio (combined pricing and cost) of the investment.

The example shown in FIG. 6 includes entries within a defined pool (Pool A) that has been identified by the user through the interface 500. Within each pool, different price packages may also be selected by the user through the interface 500 as discussed above. The price package information may indicate a grouping of investments within a particular range of prices that are charged by the underwriting institution. As shown in FIG. 6, database area 602 includes investments having a price package PP1 within Pool A, while database area 604 includes investments having price package PP2 within Pool A. Other investments that are outside of the defined investment pool and pricing packages can also be included in the available investments database 406 through identification of the particular investments by the user through the interface 500. For example, each of the investments in the current investment line-up can be included in the available investments database 406 regardless of their grouping within pricing packages and defined investment pools.

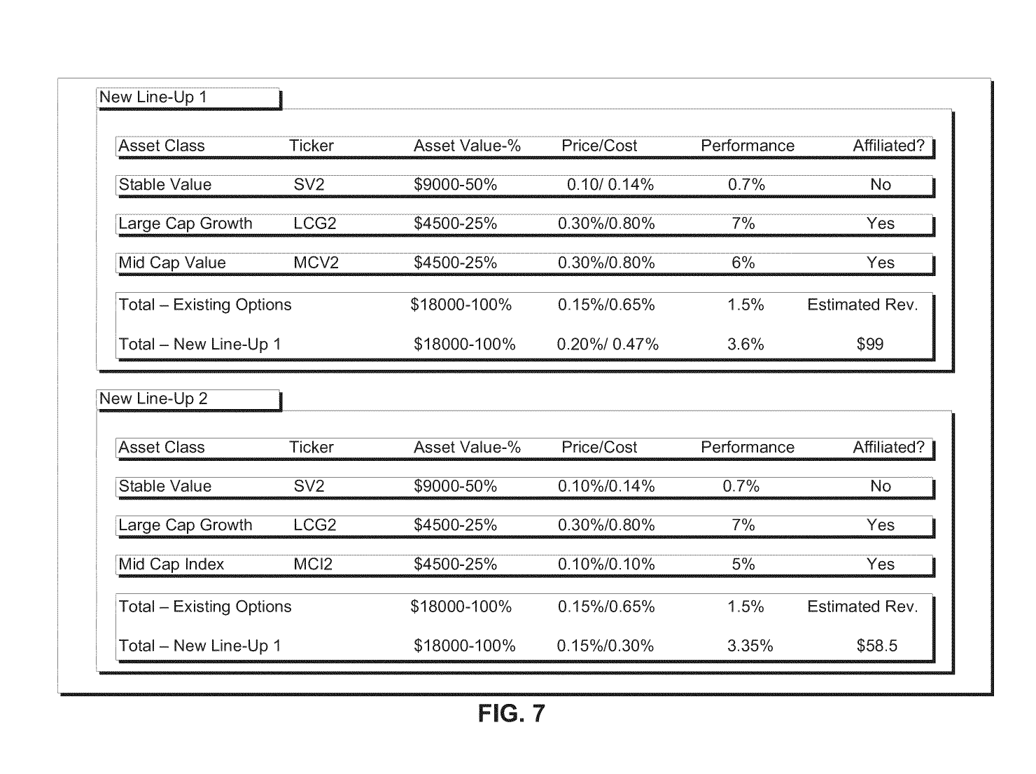

FIG. 7 illustrates a computer display having selected investment line-up options. The examples shown in FIG. 7 present alternative line-ups to the current investment line-up which is entered by the user and which meet the objectives that are defined by the user through the interface 500 as discussed above with reference to FIG. 5. Although only three investments are shown in each line-up in the example illustrated, one of ordinary skill in the art will recognize that the number of investments in the line-up is not limited thereto and that any number of investments can be included in the current line-up of investments and the suggested new line-ups. Further, while the new line-ups include the same number of investments as those in the current line-up entered through the interface 500, the substitution of investments in the line-up are not limited to one-to-one mappings. Rather, one-to-many and many-to-one mappings within each investment classification may be used to substitute investments from the current line-up of investments to a new line-up of investments.

In new line-up 1 shown in FIG. 7, investments are mapped within each asset class to new investments which reduce expenses, have historically greater returns, and satisfy defined affiliation and estimated pricing (e.g., revenue rate) for the under-writing institution. As shown, the investment allocation by asset classification is maintained (e.g., 50% stable value, 25% large cap growth, and 25% mid cap value) from the current line-up to new line-up 1. New line-up 1 offers a mapping of actively managed investments in the current line-up (e.g., SV1, LCG1, MCV1) to actively managed investments in the new line-up 1 alternative (e.g., SV2, LCG2, MCV2). As an alternative, new line-up 2 offers a mapping of actively managed investments to a combination of actively managed investments and index funds (e.g., SV2, LCG2, and MCI2). Both alternatives, as well as other pre-defined line-up displays may be illustrated to the user through the user interface. For example, other alternate investment line-up mappings that can automatically be generated for consideration can include the utilization of affiliated target date or target allocation funds as substitutes for target date and target allocation funds that are present in the current line-up. Each of the alternatives displayed are the matching solutions of combined investments that satisfy the objectives that are provided by the user for each of the investment mapping modes (e.g., active investment to active investments, active investments to active investments and index funds, active investments to active investments utilizing affiliated target date and target allocation funds, and active investments to active investments and index funds utilizing affiliated target date and target allocation funds.). The user may then select one of the line-ups in order to generate their investment proposal. In some embodiments, the system may display a plurality of combinations of investments to the user and the user may select one or more of the plurality of combinations to generate a comparison of the new line-ups with the current investment line-up. The user may then select a final investment line-up based on the result of the comparison for their investment proposal.

Each of the various illustrative logical blocks, modules, processors, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium or memory. Computer-readable media include both non-transitory computer storage media and communication media including any medium that facilitates transfer of a computer program. A storage medium may be any available media that can be accessed by a computer. By way of example, and not limitation, such computer-readable media can include non-transitory computer-readable media including RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium can include a communication signal path. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The system may include various modules as discussed above. As can be appreciated by one of ordinary skill in the art, each of the modules may include one or more of a variety of sub routines, procedures, definitional statements and macros. Each of the modules may be separately compiled and linked into a single executable program. Therefore, the description of each of the modules is used for convenience to describe the functionality of the disclosed embodiments. Thus, the processes that are undergone by each of the modules may be redistributed to one of the other modules, combined together in a single module, or made available in, for example, a shareable dynamic link library.

The system may be used in connection with various operating systems such as Linux®, UNIX® or Microsoft Windows®. The system may be written in any conventional programming language such as C, C++, BASIC, Pascal, or Java, and ran under a conventional operating system. The system may also be written using interpreted languages such as Visual Basic (VB.NET), Perl, Python or Ruby.

It will be appreciated by those skilled in the art that various modifications and changes may be made without departing from the scope of the described technology. Such modifications and changes are intended to fall within the scope of the embodiments that are described. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

What is claimed is:

1. An apparatus comprising:
computer memory storing data regarding a plurality of investments;
a computer interface configured to receive data indicative of a plurality of investment objectives, the investment objectives including an asset allocation by classification;
an investment selection processing circuit operatively coupled to the memory and the interface and configured to:
generate combinations of investments from the plurality of investments based on the asset allocation by classification;
determine, for each combination of investments from the combinations of investments, whether each combination of investments meets the plurality of investment objectives; and
identify and output one or more combinations of investments based on said generating and said determining.

2. The apparatus of claim 1, wherein the investment selection processing circuit is configured to receive a current investment line-up, and wherein the investment selection processing circuit is configured to determine the asset allocation by classification based on the current investment line-up.

3. The apparatus of claim 2, wherein the investment selection processing circuit is configured to map investments from the current line-up to investments in the determined investment line-up having the same classification.

4. The apparatus of claim 2, wherein the investment selection processing circuit is configured to map investments from the current line-up to investments in the determined investment line-up having different classifications.

5. The apparatus of claim 1, wherein the investment objectives include data indicative of an identified stable value investment fund, an identified target date, and an identified target allocation of investments.

6. The apparatus of claim 1, further comprising an investment classification and performance processing circuit, operatively coupled with the memory, and configured to automatically retrieve data indicative of the classification, expense, and performance of each investment in a selected set of investments, the investment classification and performance processing circuit being further configured to store data indicative of the classification, expense, and performance of the investments in the memory.

7. The apparatus of claim 1, wherein the plurality of investment objectives include data indicative of the number of investments that are to be included in an investment line-up, and wherein the investment selection processing circuit is configured to combine the investments in groups corresponding to the number of investments that are to be included in an investment line-up.

8. The apparatus of claim 1, wherein the processing circuitry is configured to calculate a score for each combination of investments based on the extent to which each combination of investments meets the investment objectives.

9. The apparatus of claim 8, wherein the processing circuitry is further configured to determine a combination of investments to be included in an investment line-up based on the determined scores from the combinations of investments, and wherein the apparatus further comprises a display configured to output the determined combination of investments.

10. A method comprising:
storing data in a computer memory regarding a plurality of investments;
receiving, via a computer interface, data indicative of a plurality of investment objectives, the investment objectives including an asset allocation by classification;
generating, via a processing circuit, combinations of investments from the plurality of investments based on the asset allocation by classification;
determining, via the processing circuit, for each combination of investments from the combinations of investments, whether each combination of investments meets the plurality of investment objectives; and
identifying and outputting one or more combinations of investments based on said generating and determining.

11. The method of claim 10, receiving a current investment line-up and determining the asset allocation by classification based on the current investment line-up.

12. The method of claim 11, further comprising mapping investments from the current line-up to investments in the determined investment line-up having the same classification.

13. The method of claim 11, further comprising mapping investments from the current line-up to investments in the determined investment line-up having different classifications.

14. The method of claim 10, wherein the investment objectives include data indicative of an identified stable value investment fund, an identified target date, and an identified target allocation of investments.

15. The method of claim 10, further comprising automatically retrieving, via a classification and performance processing circuit; data indicative of the classification, expense, and performance of each investment in a selected set of investments, and storing data indicative of the classification, expense, and performance of the investments in the memory.

16. The method of claim 10, wherein the plurality of investment objectives include data indicative of the number of investments that are to be included in an investment line-up, the method further comprising combining the investments in groups corresponding to the number of investments that are to be included in an investment line-up.

17. The method of claim 10, further comprising calculating a score for each combination of investments based on the extent to which each combination of investments meets the investment objectives.

18. A non-transitory computer readable medium having stored thereon a computer program product that is capable of being executed by computer processing circuitry, the computer program product including instructions for causing the processing circuitry to:
store data in a computer memory regarding a plurality of investments;
receive data indicative of a plurality of investment objectives, the investment objectives including an asset allocation by classification;
generate combinations of investments from the plurality of investments based on the asset allocation by classification;
determine for each combination of investments from the combinations of investments, whether each combination of investments meets the plurality of investment objectives; and
identify and output one or more combinations of investments based on said generating and said determining.

19. The non-transitory computer readable medium of claim 18, wherein the computer program product includes instructions causing the processing circuitry to receive a current investment line-up and determining the asset allocation by classification based on the current investment line-up.

20. The non-transitory computer readable medium of claim 19, wherein the computer program product includes instructions causing the processing circuitry to map investments from the current line-up to investments in the determined investment line-up having the same classification.

21. The non-transitory computer readable medium of claim 19, wherein the computer program product includes instructions causing the processing circuitry to map investments from the current line-up to investments in the determined investment line-up having different classifications.

22. The non-transitory computer readable medium of claim 18, wherein the investment objectives include data indicative of an identified stable value investment fund, an identified target date, and an identified target allocation of investments.

23. The non-transitory computer readable medium of claim 18, wherein the computer program product includes instructions causing the processing circuitry to automatically retrieve data indicative of the classification, expense, and performance of each investment in a selected set of investments, and store data indicative of the classification, expense, and performance of the investments in the memory.

24. The non-transitory computer program product of claim 18, wherein the computer program product includes instructions causing the processing circuitry to calculate a score for each combination of investments based on the extent to which each combination of investments meets the investment objectives.
